(19) United States
(12) Patent Application Publication
(10) Pub. No.: US 2024/0351214 A1
(43) Pub. Date: Oct. 24, 2024

(54) METHOD FOR CONTROLLING A HANDLING SYSTEM AND HANDLING SYSTEM

(71) Applicant: J.Schmalz GmbH, Glatten (DE)

(72) Inventors: Matthias FREY, Sulz-Dürrenmettstetten (DE); Steffen KRIEG, Waldenbuch (DE)

(73) Assignee: J.Schmalz GmbH, Glatten (DE)

(21) Appl. No.: 18/630,901

(22) Filed: Apr. 9, 2024

(30) Foreign Application Priority Data
Apr. 20, 2023 (DE) 10 2023 110 111.0

(51) Int. Cl. B25J 9/16

(52) U.S. Cl. CPC B25J 9/1697; B25J 9/1612; B25J 9/163

(57) ABSTRACT

A computer-implemented method/product for controlling a handling system, comprising performing one or more control cycles, each control cycle comprising receiving image data that represents an image of at least one portion of an item to be gripped, which image is captured by a detection device, determining a target gripping point on the item for the end effector, comprising analyzing the image data, generating control signals which cause the at least one robot to grip the item at the target gripping point by means of the end effector, wherein determining the target gripping point comprises analyzing the image data by two or more mutually independent gripping point determination algorithms, wherein each of said gripping point determination algorithms determines at least one gripping point candidate, and wherein the gripping point candidates determined by the two or more gripping point determination algorithms form a set Me of gripping point candidates.

The invention relates to a method for controlling a handling system and to a handling system.

Handling systems are used, for example, when picking goods in warehouses, where they are used in particular to grip goods from a storage container (source container) having a plurality of goods (so-called “bin-picking”) and to move them to another location, e.g., into a transport container (target container). Such handling systems usually comprise a robot with a robot arm on which an end effector for gripping an item is arranged.

In this context, it is known to first capture an image of the source container and the items accommodated therein, and to determine gripping points therefrom by computer, at which gripping points the end effector can grip the items. One of the determined gripping points is then selected as the target gripping point. The robot then approaches this target gripping point with its end effector, grips the corresponding item and brings it to a deposit location in the target container.

The invention relates to the object of improving the determination of a target gripping point.

This object is achieved by a method having the features of claim 1. The method is a method for controlling a handling system. The method is computer-implemented. In particular, the method runs on a data processing system or computer of the handling system.

The handling system comprises at least one robot, for example a multi-axis robot, a SCARA robot, or a collaborating lightweight robot (Cobot). It is also conceivable that the at least one robot is a linear axis, in particular an x-y manipulator. An end effector for gripping an item is arranged on the at least one robot. In particular, the robot is designed to displace the end effector and an item optionally gripped therewith. The end effector can in particular be a suction gripping apparatus, for example an elastomer suction gripper or a vacuum gripper. The end effector can have one or more gripping locations by means of which the end effector can grip the item.

The handling system also comprises a detection device or recognition device for detecting one or more items to be gripped. In particular, the detection device is designed to detect a work region of the handling system and the items arranged therein. The detection device comprises at least one detection unit which is designed to detect at least one item to be gripped, in particular a work region comprising a plurality of items, by means of an imaging method. The at least one detection unit is in this respect in particular designed to record at least one image, in particular a 3D image, of the work region. The at least one detection unit is preferably designed as a camera, in particular a 3D camera, for example as a CCD camera. It is also conceivable for the at least one detection unit to be a laser scanner, ultrasonic sensor, or radar sensor. It is also conceivable for the detection device to comprise a plurality of detection units of different types. The detection device can also be configured to capture the image of a target region, in particular target container, of the handling system in which target region a gripped item is to be placed. In this respect, the detection device can have at least one detection unit, in particular a camera, which is designed to detect the target region by means of an imaging method. The detection device can be held on the robot, in particular a robot arm of the robot. The detection device can also be provided separately from the robot. In particular, the detection device can be arranged in a stationary manner relative to the work region, in particular the source container.

The handling system also comprises a control device for controlling the handling system, in particular for controlling the robot and the detection device. The control device comprises a data processing system, in particular on which the computer-implemented method runs. The control device also comprises a non-volatile memory device, in particular on which a computer program is stored, wherein the computer program comprises commands which, when executed by the data processing system of the control device, cause said control device to carry out the proposed method.

The handling system can also comprise the above-mentioned work region, in particular the source container. In particular, several items can be provided in the work region, in particular the source container, in particular accommodated therein. In this respect, the handling system can comprise a work region with a plurality of items arranged therein. The handling system can also comprise a target region, in particular a target container, for accommodating items. It is conceivable that the target container is empty at the beginning of a handling process. It is also conceivable that the target container is already partially filled, for example with objects, at the beginning of a handling process. In particular, the source container can be a storage container and the target container can be a transport container, e.g., a parcel box.

The method comprises performing a control cycle or a plurality of control cycles in chronological succession.

A respective control cycle comprises the following steps:
a) receiving image data that represent an image of at least one portion of an item to be gripped, which image is captured by the detection device. The image data can also represent an image of a plurality of items, which image is captured by means of the detection device, in particular an image of the work region comprising a plurality of items. The method can also comprise controlling the detection device before receiving the image data in order to capture an image of at least one portion of an item to be gripped, in particular an image of the work region comprising a plurality of items. As mentioned above, the detection unit can be designed as a camera, in particular a 3D camera, for example as a CCD camera. The capturing of the image can then comprise the recording of an optical image of the item or the work region and the items arranged therein. It is also conceivable that the capturing of the image of the item or the work region comprises scanning the item or the work region and the items arranged therein, for example by means of a laser scanner, an ultrasonic sensor and/or a radar sensor. It is also conceivable that the capturing of the image comprises the simultaneous or sequential capture of an image by means of a plurality of different detection units.
b) Analyzing the image data and determining a target gripping point on the item for the end effector. In the present context, the target gripping point in particular denotes a gripping point at which the end effector is to actually grip the item. Determining the target gripping point comprises the following sub-steps:
   b1) analyzing the image data by two or more mutually independent gripping point determination algorithms, wherein each of these gripping point determination algorithms determines one or more gripping point candidates at which the item or one of the plurality of items can be gripped with the end effector as a result of the analysis of the image data. In other words, the image data represent an input variable of a particular gripping point determination algorithm. A particular output variable of the gripping point determination algorithms is at least one gripping point candidate. In the present context, the gripping point candidate denotes in particular a possible gripping point at which an item can be gripped by means of the end effector. A gripping point or gripping point candidate can in particular be formed by a section of an outer surface of an item. The gripping point candidates determined by the two or more gripping point determination algorithms form a set Mₑ of determined gripping point candidates. The gripping point candidates are preferably determined by means of well-known image processing methods. In the event that the image data comprise information about a plurality of items, the gripping point determination algorithms can determine one or more gripping point candidates for each of these items, or at least a subset of these items. The different gripping point determination algorithms can run in parallel or sequentially.
   b2) selecting a gripping point candidate from the set Mₑ of determined gripping point candidates as the target gripping point depending on one or more specified gripping point selection criteria. The at least one gripping point selection criterion thus forms a boundary condition in the selection of the target gripping point. The at least one gripping point selection criterion is in particular stored on the non-volatile memory device. It is also possible for the method to additionally comprise a step of receiving gripping point selection criteria data which represent the at least one gripping point selection criterion.
c) Generating control signals comprising commands which cause the at least one robot to grip the item at the target gripping point by means of the end effector. In particular, the control signals comprise commands which cause the control device to control the at least one robot depending on the determined target gripping point, in particular in such a way that the robot grips the item at the target gripping point by means of the end effector. The control signals preferably comprise commands which cause the at least one robot to carry out a handling task, in particular comprising gripping of the item by means of the end effector, transferring the item into a target region, and depositing the item at a target deposit location of the target region.

The proposed method makes it possible to select an optimal target gripping point as required. Since two or more gripping point determination algorithms are provided, it is in particular possible to analyze the image data with different criteria and to select the best result at the end. For example, it is conceivable that gripping point determination algorithms of different speed and different precision are used. Then, for example, depending on an application situation either the fastest (but possibly more imprecise) gripping point determination algorithm or the slower (but possibly more precise) gripping point determination algorithm can supply the target gripping point. In addition, it is conceivable that the different gripping point determination algorithms are designed for different types of items. The proposed method therefore makes it possible to reliably grip a large bandwidth of different items, which is advantageous, for example, in bin picking of different items from a container.

As mentioned above, it is conceivable for the image data to comprise only information about a single item. Then, the method can comprise performing a single control cycle. It is also conceivable for the image data to comprise information relating to a plurality of items, for example to a source container having a plurality of items arranged therein. Then, the method can comprise performing multiple control cycles one after the other, wherein an item is analyzed and gripped in each cycle.

It is conceivable for the end effector to have two or more gripping locations by means of which the end effector can grip the item. In an embodiment of the end effector as a suction gripping apparatus, the suction gripping apparatus can have, for example, two or more suction locations for suctioning an item. It is then conceivable that in step b2), two or more, in particular a number corresponding to the gripping locations, of the determined gripping point candidates are selected as particular target gripping points for the gripping locations. The control signals determined in step c) can then comprise commands which cause the at least one robot to grip the item by means of the gripping locations of the end effector at the target gripping points.

A gripping point candidate can be characterized in particular by its coordinates (X, Y, Z) and/or its orientation (A, B, C) in a coordinate system of the handling system. Alternatively or additionally, a gripping point candidate can comprise information about the corresponding item or can be characterized thereby. In particular, a gripping point candidate can comprise information about a geometry of the item and/or a position of the item in a coordinate system of the handling system. In particular, a gripping point candidate can comprise information about an outer surface of the corresponding item, for example about its coordinates in the coordinate system of the handling system. This allows a segmentation of the work region.

Within the scope of an advantageous development, the method can comprise the determination of target selection data which contain information as to which of the two or more gripping point determination algorithms has determined the gripping point candidate selected as the target gripping point in a control cycle. The target selection data can be determined in each control cycle. The target selection data can also be determined only at certain time intervals, for example after each tenth control cycle.

Additionally or alternatively, the method can comprise the generation of selection frequency data which, for each gripping point determination algorithm, represent how often in a specified time interval comprising a plurality of control cycles this gripping point determination algorithm has determined the gripping point candidate selected as the target gripping point.

The determination of the target selection data and/or the selection frequency data makes it possible to draw conclusions about which of the gripping point determination algorithms is most suitable overall for the present application situation. This makes it possible, for example, for a manufacturer or provider of a gripping point determination algorithm to draw conclusions about the suitability of its gripping point determination algorithm for the given application situation and, if necessary, to adapt the gripping point determination algorithm, e.g. boundary conditions or parameters. It can be advantageous if the target selection data and/or the selection frequency data comprise information about the handling system (for example which robot or which end effector is used, or which type of item was gripped). Furthermore, the target selection data and/or the selection frequency data enable the providers of the gripping point determination algorithms to be paid according to actual use (“pay per pick”). For example, the target selection data and/or the selection frequency data can additionally contain instructions which cause an external payment provider to remunerate the provider of the particular gripping point determination algorithm, in particular depending on a number of the gripping point candidates selected as target gripping points, which have been determined by this gripping point determination algorithm. In particular, an associated incoming money transfer can be secured/executed using blockchain technology.

In this context, it can be advantageous if the method comprises transmitting the target selection data and/or the selection frequency data to an external computer or to an external data network, in particular to a computer or to a data network of a provider or developer providing the particular gripping point determination algorithm, or a payment provider. This allows direct technical feedback for the provider.

As mentioned above, one of the determined gripping point candidates is selected as the target gripping point depending on a specified gripping point selection criterion or a plurality of specified gripping point selection criteria. In particular, the specified gripping point selection criterion can be one of the following criteria, or the plurality of gripping point selection criteria can comprise one or more of the following criteria:
a confidence value for the gripping point candidate determined by the particular gripping point determination algorithm. In this respect, the determination of the gripping point candidates by the gripping point determination algorithms can comprise determining a confidence value for each gripping point candidate. The confidence value represents in particular the uncertainty or certainty with which the determination of the at least one gripping point candidate is afflicted. In particular, the confidence value can assume a value between 0 (high uncertainty/low uncertainty) and 1 (low uncertainty/high uncertainty). Preferably, that gripping point candidate is selected as the target gripping point which has the highest confidence value;
a position, in particular coordinates, and/or orientation of the gripping point candidate in a coordinate system of the handling system. For example, in one embodiment with source containers and a plurality of items arranged therein, a gripping point candidate can then preferably be selected as the target gripping point if it is comparatively high up in the source container (and can thus be gripped well);
a probability of success when gripping the item at the gripping point candidate. The probability of success represents in particular a gripping success to be expected while gripping. In particular, the method can additionally comprise the step of determining or receiving success probability data (see below). Preferably, the gripping point candidate is selected as the target gripping point which has the highest probability of success. It is also conceivable that a probability of success during the second gripping of the item at the gripping point candidate forms a gripping point selection criterion, in particular in the event that the first gripping fails.
a property or type of the item to be gripped, in particular its geometry, surface quality and/or material properties. For example, it is conceivable that a material stiffness of the item forms a gripping point selection criterion (for example, different gripping points can be advantageous when gripping a bag or a fixed cardboard box). The method can comprise the step of receiving or determining item data which represents a property or type of the item to be gripped.
energy consumption to be expected when gripping the item at the gripping point candidate. Such energy consumption can be influenced, for example, by the position and/or orientation of the gripping point candidate, a required gripping force for gripping the item at the gripping point candidate (for example a required negative pressure in an embodiment of the end effector as a suction gripping apparatus) or a required movement path of the robot. The method can comprise a step of receiving or determining energy consumption data which represent energy consumption to be expected when gripping the item at the gripping point candidate.
a property or type of the employed end effector, for example a geometry or arrangement of a gripping element of the end effector. In an embodiment of the end effector as a suction gripping apparatus, a number and/or arrangement of the at least one suction location of the suction gripping apparatus can form a gripping point selection criterion, for example. The method can comprise a step of receiving end effector data which represent a property or a type of the employed end effector.

The gripping point selection criteria can be specified in a fixed manner; preferably, the gripping point selection criteria can be selected and/or weighted differently.

In the context of an advantageous development, the selection of the gripping point candidate as the target gripping point can comprise the reception of gripping point selection criteria data which represent a user-specified selection of one or more of the gripping point selection criteria. The gripping point candidate as the target gripping point can then be selected depending on the selected gripping point selection criterion or the selected gripping point selection criteria.

Additionally or alternatively, selecting the gripping point candidate as the target gripping point can comprise the reception of gripping point selection criteria weighting data which represents a user-specified weighting of the gripping point selection criteria. Then, the gripping point candidate can be selected as the target gripping point depending on the weighted gripping point selection criteria.

Such an embodiment makes it possible, for example depending on the application situation, to take into account different gripping point selection criteria or to weight them to different degrees. For example, the confidence value and/or the probability of success can then preferably be selected as a gripping point selection criterion if delicate items are to be transported in order to thus reduce the risk of undesired dropping of the item.

Within the scope of an advantageous development, it is also conceivable for the determined gripping point candidates to be evaluated depending on the specified or selected gripping point selection criteria and sorted in a ranking list. The gripping point candidate as the target gripping point can then be selected depending on a position of the gripping point candidate in the ranking list. In particular, the uppermost gripping point candidate in the ranking list is selected as the target gripping point.

The two or more (active) gripping point determination algorithms can be specified in a fixed manner. In some embodiments, however, it is also conceivable that the two or more subsequently active gripping point determination algorithms are first selected from a set Mₐ of available gripping point determination algorithms. In this respect, the determination of the target gripping point (step b) can also comprise, prior to step b1), the selection of the two or more gripping point determination algorithms from a set Mₐ of available gripping point determination algorithms, in particular those stored in the non-volatile memory device. Preferably, the two or more gripping point determination algorithms are selected from the set Mₐ depending on at least one specified algorithm selection criterion (see below). For example, the two or more gripping point determination algorithms can be selected depending on a type of item to be gripped. The method can thus comprise the specification of at least one algorithm selection criterion.

Within the scope of a further advantageous development, in particular after determining the gripping point candidates by the gripping point determination algorithms, first one of the gripping point determination algorithms can be selected as the target evaluation algorithm, and then the target gripping point can be selected from the set of the gripping point candidates determined by the target evaluation algorithm. In particular, selecting the gripping point candidate as the target gripping point (step b2) can comprise selecting one of the two or more (active) gripping point determination algorithms as the target evaluation algorithm depending on at least one specified algorithm selection criterion (see below). Then the gripping point candidate determined by the target evaluation algorithm can be selected as the target gripping point. If the target evaluation algorithm has calculated a plurality of gripping point candidates, one of these gripping point candidates can be selected as the target gripping point, in particular depending on the at least one gripping point selection criterion described above.

The at least one algorithm selection criterion for selecting the two or more gripping point determination algorithms from the set Mₐ of available gripping point determination algorithms and the at least one algorithm selection criterion for selecting the target evaluation algorithm can be identical. For example, the at least one specified algorithm selection criterion can comprise one or more of the following selection criteria:
a particular evaluation speed of the gripping point determination algorithms, in particular a time or a calculation duration until the at least one gripping point candidate or a first gripping point candidate is determined. For example, the gripping point determination algorithm can be selected as the target evaluation algorithm which has most quickly determined a gripping point candidate.
a probability of success to be expected when gripping the item at a gripping point candidate determined by the particular gripping point determination algorithm. In particular, the gripping point determination algorithm is selected as the target evaluation algorithm which has the highest probability of success.
a property or type of the item to be gripped, in particular its geometry, surface quality and/or material properties (see also above for the gripping point selection criteria).
a property or type of the employed end effector. For example, a different gripping point determination algorithm can be advantageous for a vacuum gripper than for a magnetic gripper.
a confidence value determined by the particular gripping point determination algorithm, in particular the highest determined confidence value.

The algorithm selection criteria are preferably stored on a non-volatile memory device, in particular the non-volatile memory device of the control device. The method can also comprise the step of receiving algorithm selection criteria data which represents the algorithm selection criteria. The algorithm selection criteria can be specified in a fixed manner. However, the algorithm selection criteria can be selected and/or weighted differently.

Within the scope of an advantageous development, the selection of the gripping point determination algorithm as the target evaluation algorithm can comprise receiving algorithm selection criterion data which represent a user-specified selection of one or more of the algorithm selection criteria. The gripping point determination algorithm can then be selected as a target evaluation algorithm depending on the selected algorithm selection criterion, or the selected algorithm selection criteria.

Additionally or alternatively, the selection of the gripping point determination algorithm as the target evaluation algorithm can comprise the reception of algorithm selection criteria weighting data which represents a user-specified weighting of the algorithm selection criteria. Then, the gripping point determination algorithm can be selected as the target evaluation algorithm depending on the weighted algorithm selection criteria.

For example, it is conceivable for the gripping point determination algorithm to be selected at the highest evaluation speed when a handling task to be carried out requires rapid implementation (time pressure, many items, high robot gripping rate). It is also conceivable, for example, for the gripping point determination algorithm to be selected with the highest confidence value and/or probability of success when delicate items are to be transported.

Within the scope of an advantageous development, the selection of the target evaluation algorithm (step b2.1 above) can comprise the following steps:
b2.1.1) selecting one of the two or more gripping point determination algorithms as a test algorithm, wherein the test algorithm is selected depending on at least one of the specified algorithm selection criteria;
b2.1.2) specifying a gripping point rejection criterion or a plurality of gripping point rejection criteria;
b2.1.3) checking whether the at least one gripping point candidate determined by the test algorithm meets the specified gripping point rejection criterion or meets one of the specified gripping point rejection criteria, wherein, when the at least one gripping point candidate does not meet a gripping point rejection criterion, the test algorithm is selected as the target evaluation algorithm.

In particular, when the at least one gripping point candidate meets the specified gripping point rejection criterion or one of the plurality of specified gripping point rejection criteria, steps b2.1.1) to b2.1.3) are repeated, wherein in step b2.1.1), another of the two or more gripping point determination algorithms is then selected as the test algorithm.

For example, the specified gripping point rejection criterion can be one of the following criteria or the plurality of specified gripping point rejection criteria can comprise one or more of the following criteria:
a. Gripping point candidate cannot be approached by the at least one end effector, for example, because the gripping point candidate lies outside a movement radius of the robot, or because the gripping point candidate lies in a corner of a source container that the end effector cannot approach due to its size.
b. The end effector approaching the gripping point candidate would lead to a collision of the end effector with another item with a given probability.

The selection of the gripping point candidate as the target gripping point and/or the selection of the gripping point determination algorithm as the target evaluation algorithm in a particular control cycle can in particular access knowledge from one or more previous control cycles. For example, it is conceivable that the methods of machine learning are implemented.

In the context of a further advantageous development, the handling system can, for example, comprise a monitoring device which is designed to monitor the gripping of the item at the gripping point candidate selected as the target gripping point, in particular the execution of the handling task. The monitoring device can in particular be used to determine the probability of success mentioned above. In particular, the method can comprise the reception of gripping success data generated by means of the monitoring device, wherein the gripping success data represent a gripping success when gripping the item at the target gripping point. The probability of success can then be determined from the gripping success data, which represents a gripping success to be expected when gripping an item at a gripping point candidate determined by that gripping point determination algorithm, which has determined the gripping point candidate selected as the target gripping point in this control cycle. The probability of success determined in this way in a control cycle can then form a gripping point selection criterion and/or an algorithm selection criterion in a subsequent control cycle.

The monitoring device can, for example, comprise one or more cameras which are designed to capture the image of the gripping of the item at the target gripping point, in particular to capture whether the item has been reliably gripped and deposited again. In an embodiment of the end effector as a suction gripping apparatus, the monitoring device can, for example, comprise a vacuum sensor which is designed to monitor a negative pressure prevailing in the suction gripping apparatus. It is also conceivable for the monitoring device to comprise a weighing device which is designed to weigh a source container, in particular before and after the gripping of an item. It is also conceivable for the items to have an RFID tag. The monitoring device can then comprise an RFID detector.

In some embodiments, it is conceivable for the handling system to comprise a plurality of end effectors which can optionally be coupled to the at least one robot, and/or for the handling system to comprise a plurality of robots on which at least one end effector for gripping an item is arranged in each case. The selection of a gripping point candidate as the target gripping point and/or the selection of a gripping point determination algorithm as the target evaluation algorithm can take place depending on which end effector is coupled to the at least one robot and/or which of the optional plurality of robots is to grip the item. In this respect, the best gripping point can be determined for a given configuration of the handling system.

The object described above is also achieved by a handling system according to claim 16. The handling system comprises at least one robot on which an end effector for gripping an item is arranged, a detection device having at least one detection unit, in particular a camera, which is designed to capture in particular an image of an item to be gripped, and having a control device for controlling the handling system, in particular the robot and the detection device. The control device comprises a data processing system and a non-volatile memory device. A computer program is stored on the non-volatile memory device and comprises commands which, when executed by the data processing system of the control device, cause the data processing system to execute the method described above.

The advantages and optional features described above in connection with the method can also serve to design the handling system, so that reference is made to the above disclosure in this respect in order to avoid repetition.

In particular, the computer program can comprise two or more evaluation computer programs which each comprise a gripping point determination algorithm for determining gripping point candidates on the basis of image data of an item to be gripped, wherein the evaluation computer programs comprise commands which, when executed by the data processing system, each cause the data processing system to analyze the image data by means of the particular gripping point determination algorithm and to determine at least one gripping point candidate.

In particular, the computer program can also comprise a selection computer program which comprises commands that, when executed by the data processing system, cause the data processing system to select one of the gripping point determination algorithms of the evaluation computer programs as a target evaluation algorithm.

As mentioned above, the end effector is preferably a suction gripping apparatus for suctioning an item. For example, the suction gripping apparatus can be one or more elastomer suction grippers, or a vacuum gripper. It is conceivable for the suction gripping apparatus to comprise a single suction location for suctioning an item. It is also conceivable for the suction gripping apparatus to comprise a plurality of suction locations for suctioning an item. In the latter case, the gripping of an item can in particular comprise the suctioning of the item by means of the suction locations at a particular target gripping point (see above).

The object described above is also achieved by a computer program product according to claim 18. The computer program product comprises commands which, when the method is executed by a computer, in particular by the data processing system of the control device of the handling system, cause the computer, in particular the data processing system, to carry out the method described above.

The invention is explained in more detail below with reference to the figures. In the drawings:

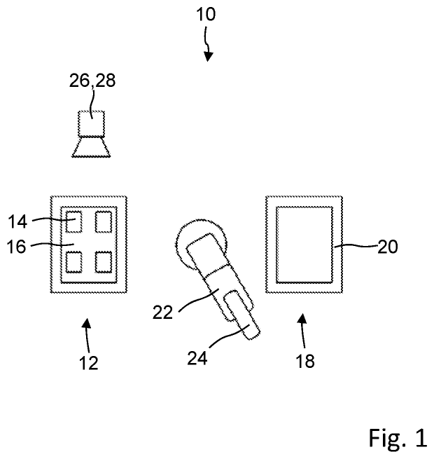

FIG. 1 shows a simplified schematic representation of an embodiment of a handling system in a plan view; and

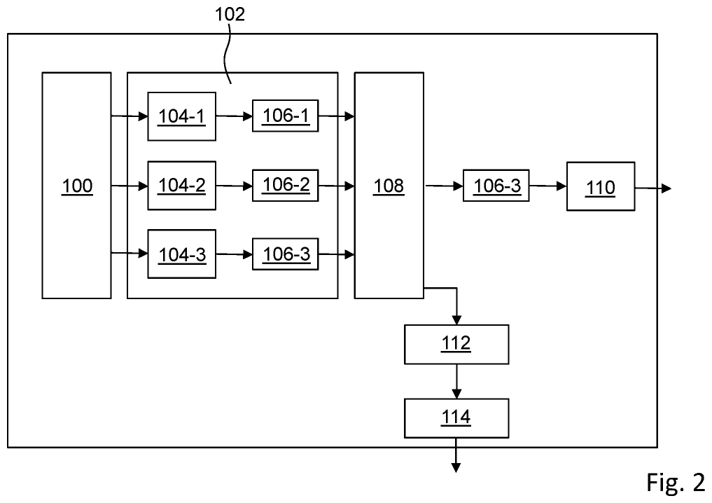

FIG. 2 shows a diagram for explaining an exemplary method for controlling the handling system.

In the following description and in the figures, identical reference signs are in each case used for identical or corresponding features.

FIG. 1 shows, in a simplified schematic representation, an embodiment of a handling system which is denoted as a whole by reference sign 10.

In the example, the handling system 10 comprises a work region 12 in which a plurality of items 14 is arranged. In the specific example, the work region 12 is formed by a source container 16 in which the items 14 are accommodated.

In the example, the handling system 10 also comprises a target region 18 in which the items 14 are to be transferred within the scope of a handling process described below. In the example, the target region 18 is formed by a target container 20 for accommodating the items 14.

The handling system 10 also comprises a robot 22. The robot 22 is designed as an industrial robot, by way of example. As mentioned above, the robot 22 can be designed, for example, as a multi-axis robot, SCARA robot or collaborating robot. However, any other design of the robot 22 is also conceivable.

The robot 22 is designed to transfer items 14 from the work region 12 (source container 16) into the target region 18 (target containers 20).

An end effector 24 for gripping an item 14 is arranged on the robot 22. By way of example, the end effector 24 can be a suction gripper.

The handling system 10 also comprises a detection device 26 which is designed to detect the work region 12 (source container 16). In the specific example, the detection device 26 comprises a detection unit 28, in particular a camera, which is designed to capture the image of the work region 12 and the items 14 arranged therein. In embodiments (not shown), it is also conceivable for the detection device 26 to have a further detection unit 28 which is designed to capture an image of the target region 18, in particular the target container 20.

The handling system 10 also comprises a control device (not shown) which is designed to control the robot 22 and the detection device 26. As mentioned above, the memory device comprises a data processing system and a non-volatile memory device.

In embodiments (not shown), it is also conceivable for the detection device 26 or the detection unit 28 to be held on the robot 22 and hence be displaceable by the robot 22. In this way, the detection unit 28 can detect both the work region 12 (source container 16) (in particular when the robot 22 faces the work region 12) and the target region 18 (target container 20) (in particular when the robot 22 faces the target region 18.

In further embodiments (not shown), it is also conceivable for the detection device 26 to have a plurality of detection units 28 which are each designed to capture an image of the work region 12. It is also conceivable for the detection device 26 to additionally comprise at least one detection unit 28 which is designed to capture an image of the target region 18 (target container 20).

In the following, an exemplary control method for a handling system, for example for the handling system 10 according to FIG. 1, is described with reference to FIG. 2. The method is computer-implemented. In particular, the method runs on the data processing system of the control device of the handling system. In particular, a computer program is stored on the non-volatile memory device of the control device and, when executed by the data processing system, causes it to carry out the method outlined below.

In a first step 100, image data are received which represents an image of the work region 12 and the items 14 arranged therein captured by the detection unit 28. The provision of the image data can in particular comprise the previous generation of control signals which cause the detection unit 28 to record an image of the work region 12.

In a further step 102, the image data are then analyzed, and one or more gripping point candidates are determined. In the specific example, the image data are analyzed by, for example, three simultaneously running gripping point determination algorithms 104-1, 104-2, 104-3. In embodiments (not shown), it is also conceivable for the gripping point determination algorithms 104-1, 104-2, 104-3 to run one after the other, and for more or fewer gripping point determination algorithms 104-1, 104-2, 104-3 to be used.

As shown schematically in FIG. 2, each of the gripping point determination algorithms 104-1, 104-2, 104-3 determines at least one gripping point candidate 106-1, 106-2, 106-3, at which a particular item 14 can be gripped, as a result of the analysis of the image data. In the present example, in which the image data comprises information about a plurality of items 14, the gripping point determination algorithms 104-1, 104-2, 104-3 can each determine at least one gripping point candidate 106-1, 106-2, 106-3 for each of these items 14 or at least for a subset of the items 14. The sum of the gripping point candidates 106-1, 106-2, 106-3 determined by the gripping point determination algorithms 104-1, 104-2, 104-3 forms, for example, a set Mₑ of gripping point candidates.

In a further step 108, one of the gripping point candidates 106-1, 106-2, 106-3 of the set Mₑ is selected now as the target gripping point (in the present example, the gripping point candidate 106-3) based on gripping point selection criteria. As mentioned above, the gripping point selection criteria can be, for example, a confidence value determined by the particular gripping point determination algorithm 104-1, 104-2, 104-3, a probability of success, or a position and orientation of the gripping point candidates 106-1, 106-2, 106-3 in a coordinate system of the handling system 10. To avoid repetition, reference is made to the above disclosure.

On the basis of the gripping point candidate 106-3 selected as the target gripping point, control signals are then determined in a further step 110, which cause the robot 22 to grip the corresponding item with the end effector 24 at the gripping point candidate 106-3 selected as the target gripping point.

As mentioned above, target selection data are preferably determined in a step 112, which comprises information as to which of the gripping point determination algorithms 104-1, 104-2, 104-3 has determined the gripping point candidate 106-3 selected as the target gripping point (in the example of the gripping point determination algorithm 104-3).

In a further step 114, the target selection data can then be sent to an external computer or to an external data network, in particular to a computer or to a data network of the provider, which has provided the gripping point determination algorithm 104-3.

As mentioned above, it is optionally possible that, before the analysis of the image data (step 102), an additional selection step takes place in which, from an available set Mₐ of gripping point determination algorithms, the ultimately used gripping point determination algorithms are selected (in the example, the gripping point determination algorithms 104-1, 104-2, 104-3).

In embodiments (not shown), it is also possible that, before step 108, one of the gripping point determination algorithms 104-1, 104-2, 104-3 is selected as the target evaluation algorithm depending on specified algorithm selection criteria, and the target gripping point is then selected only from the set of the gripping point candidates determined by this gripping point determination algorithm.

1. A computer-implemented method for controlling a handling system, the computer-implemented method comprising:
at least one robot on which an end effector for gripping an item is arranged;
a detection device comprising at least one detection unit which is designed to capture an image of an item to be gripped; and
a control device for controlling the handling system, wherein the control device comprises a data processing system and a non-volatile memory device, wherein
the method comprising performing one or more control cycles, each control cycle comprising:
a) receiving image data that represent an image of at least one portion of the item to be gripped, which image is captured by means of the detection device,
b) determining a target gripping point for the end effector on the item, comprising analyzing the image data, and
c) generating control signals which cause the at least one robot to grip the item at the target gripping point by means of the end effector, wherein
the determination of the target gripping point comprises:
b1) analyzing the image data by two or more mutually independent gripping point determination algorithms, wherein each of these gripping point determination algorithms determines at least one gripping point candidate at which the item can be gripped with the end effector, wherein the gripping point candidates determined by the two or more gripping point determination algorithms form a set Mₑ of gripping point candidates; and
b2) selecting a gripping point candidate from the set Mₑ of determined gripping point candidates as the target gripping point depending on one or more specified gripping point selection criteria.

2. The computer-implemented method according to claim 1, wherein target selection data are determined which contain information as to which of the two or more gripping point determination algorithms has determined the gripping point candidate selected as the target gripping point in a control cycle,
and/or
wherein selection frequency data are determined which, for each gripping point determination algorithm, represent how often in a specified time interval comprising a plurality of control cycles this gripping point determination algorithm has determined a gripping point candidate later selected as the target gripping point.

3. The computer-implemented method according to claim 2, wherein the target selection data and/or the selection frequency data are transmitted to an external computer or to an external data network, or to a computer or to a data network of a provider providing the particular gripping point determination algorithm.

4. The computer-implemented method according to claim 3, wherein the at least one gripping point selection criterion comprises one of the following criteria:
a confidence value determined by the particular gripping point determination algorithm, wherein that gripping point candidate is selected as the target gripping point which has the highest confidence value;
a position or coordinates, and/or orientation of the gripping point candidate in a coordinate system of the handling system;
a probability of success when gripping the item at the gripping point candidate, wherein the gripping point candidate is selected as the target gripping point which has the highest probability of success;
a property or type of the item to be gripped, in its geometry, surface quality and/or material properties;
energy consumption to be expected when gripping the item at the gripping point candidate; and/or
a property or type of the employed end effector, a geometry and/or arrangement of a gripping location of the end effector.

5. The computer-implemented method according to claim 4, wherein selecting the gripping point candidate as the target gripping point comprises:
receiving gripping point selection criteria data which represent a user-specified selection of one or more of the gripping point selection criteria, and selecting the gripping point candidate as the target gripping point depending on the selected gripping point selection criterion or selected gripping point selection criteria;
and/or
receiving gripping point selection criteria weighting data which represents a user-specified weighting of the gripping point selection criteria, and selecting the gripping point candidate as the target gripping point depending on the weighted gripping point selection criteria.

6. The computer-implemented method according to claim 5, wherein the determined gripping point candidates are evaluated depending on gripping point selection criteria and sorted in a ranking list, wherein a gripping point candidate is selected as the target gripping point depending on a position of the gripping point candidate, wherein the uppermost gripping point candidate in the ranking list is selected as the target gripping point.

7. The computer-implemented method according to claim 1, wherein the determination of the target gripping point also comprising:
b0) selecting the two or more gripping point determination algorithms from a set Mₐ of available gripping point determination algorithms, wherein the two or more gripping point determination algorithms are selected from the set Mₐ depending on at least one specified algorithm selection criterion.

8. The computer-implemented method according to claim 7, wherein selecting the gripping point candidate as the target gripping point comprises:
b2.1) selecting one of the two or more gripping point determination algorithms as the target evaluation algorithm depending on at least one specified algorithm selection criterion, and
b2.2) selecting one of the gripping point candidates determined by the target evaluation algorithm as the target gripping point depending on the at least one gripping point selection criterion, or selecting the gripping point candidate determined by the target evaluation algorithm as the target gripping point.

9. The computer-implemented method according to claim 8, wherein the at least one specified algorithm selection criterion comprises one or more of the following selection criteria:
a particular evaluation speed of the gripping point determination algorithms, wherein the gripping point determination algorithm is selected as the target evaluation algorithm which has determined a gripping point candidate the fastest;
a probability of success when gripping the item at a gripping point candidate determined by the particular gripping point determination algorithm, wherein the gripping point determination algorithm which has the highest probability of success is selected as the target evaluation algorithm;
a property or type of the item to be gripped, in its geometry, surface quality and/or material properties;
a property or type of the employed end effector; and/or
a confidence value determined by the particular gripping point determination algorithm.

10. The computer-implemented method according to claim 9, wherein the selection of the gripping point determination algorithm as the target evaluation algorithm comprises:
receiving algorithm selection criteria data which represent a user-specified selection of one or more of the algorithm selection criteria, and selecting the gripping point determination algorithm as the target evaluation algorithm depending on the selected algorithm selection criterion or selected algorithm selection criteria;
and/or
receiving algorithm selection criteria weighting data which represent a user-specified weighting of the algorithm selection criteria, and selecting the gripping point determination algorithm as the target evaluation algorithm depending on the weighted algorithm selection criteria.

11. The computer-implemented method according to claim 10, wherein the selection of the target evaluation algorithm comprises:
b2.1.1) selecting one of the two or more gripping point determination algorithms as a test algorithm, wherein the test algorithm is selected depending on at least one of the specified algorithm selection criteria;
b2.1.2) specifying a gripping point rejection criterion or a plurality of gripping point rejection criteria; and
b2.1.3) checking whether the at least one gripping point candidate determined by the test algorithm meets the specified gripping point rejection criterion or meets one of the specified gripping point rejection criteria, wherein, when the at least one gripping point candidate does not meet a gripping point rejection criteria, the test algorithm is selected as the target evaluation algorithm.

12. The computer-implemented method according to claim 11, wherein when the at least one gripping point candidate meets the specified gripping point rejection criterion or one of the plurality of specified gripping point rejection criteria, steps b2.1.1) to b2.1.3) are repeated, wherein in step b2.1.1) a different gripping point determination algorithm is selected as a test algorithm.

13. The computer-implemented method according to claim 12, wherein the specified gripping point rejection criterion is one of the following criteria, or wherein the plurality of specified gripping point rejection criteria comprise one or more of the following criteria:
a. gripping point candidate cannot be approached by the at least one end effector; and/or
b. the end effector approaching the gripping point candidate would lead to a collision of the end effector with another item with a given probability.

14. The computer-implemented method according to claim 1, wherein the handling system comprises a monitoring device which is designed to monitor the gripping of the item at the target gripping point, the method comprising the reception of gripping success data generated by means of the monitoring device, which represent a gripping success when gripping the item at the target gripping point, wherein a probability of success is determined from the gripping success data, which represents a gripping success to be expected when gripping an item at a gripping point candidate determined by the gripping point determination algorithm which has determined the gripping point candidate selected as the target gripping point, wherein the probability of success in a subsequent control cycle forms a gripping point selection criterion and/or an algorithm selection criterion.

15. The computer-implemented method according to claim 1, wherein the handling system comprises a plurality of end effectors which can optionally be coupled to the at least one robot, and/or
wherein the handling system comprises a plurality of robots, on each of which at least one end effector for gripping an item is arranged, wherein the selection of a gripping point candidate as the target gripping point and/or the selection of a gripping point determination algorithm as the target evaluation algorithm depends on which end effector is coupled to the at least one robot, and/or which of the optional plurality of robots is to grip the item.

16. A handling system, comprising:
at least one robot on which an end effector for gripping an item is arranged;
a detection device comprising at least one detection unit, or a camera, which is designed to capture in an image of an item to be gripped; and
a control device for controlling the handling system, wherein the control device comprises a data processing system and a non-volatile memory device,
wherein a computer program is stored on the non-volatile memory device which comprises commands which, when executed by the data processing system, cause the data processing system to execute the method according to claim 1.

17. The handling system according to claim 16, wherein the end effector is a suction gripping apparatus, or an elastomer suction gripper or a vacuum gripper.

18. A computer program product comprising commands which, when the method is executed by a computer, cause the computer to execute the steps of the computer-implemented method according to claim 1.

19. A handling system comprising:
at least one robot on which an end effector for gripping an item is arranged;
a detection device comprising at least one detection unit which is designed to capture an image of an item to be gripped; and
a control device for controlling the handling system, wherein the control device comprises a data processing system and a non-volatile memory device,
wherein a computer program is stored on the non-volatile memory device which comprises commands which, when executed by the data processing system, cause the data processing system to execute one or more control cycles,
wherein each control cycle comprising:
a) receiving image data that represent an image of at least one portion of the item to be gripped, which image is captured by means of the detection device,
b) determining a target gripping point for the end effector on the item, comprising analyzing the image data, and
c) generating control signals which cause the at least one robot to grip the item at the target gripping point by means of the end effector, and
wherein the determination of the target gripping point comprises:
b1) analyzing the image data by two or more mutually independent gripping point determination algorithms, wherein each of these gripping point determination algorithms determines at least one gripping point candidate at which the item can be gripped with the end effector, wherein the gripping point candidates determined by the two or more gripping point determination algorithms form a set Mₑ of gripping point candidates; and
b2) selecting a gripping point candidate from the set Mₑ of determined gripping point candidates as the target gripping point depending on one or more specified gripping point selection criteria.
